(19) United States
(12) Patent Application Publication
(10) Pub. No.: US 2005/0006238 A1
(43) Pub. Date: Jan. 13, 2005

(54) Pressure induced reagent introduction and electrophoretic separation

(75) Inventor: Claudia B. Jaffe, Mountain View, CA (US)

Correspondence Address: CALIPER LIFE SCIENCES, INC., 605 FAIRCHILD DRIVE, MOUNTAIN VIEW, CA, 94043-2234, US

(73) Assignee: Caliper Life Sciences, Inc., Mountain View, CA (US)

(21) Appl. No.: 10/900,850

(22) Filed: Jul. 27, 2004

Related U.S. Application Data
(62) Division of application No. 09/696,749, filed on Oct. 24, 2000, now abandoned.
(60) Provisional application No. 60/161,710, filed on Oct. 27, 1999.

(51) Int. Cl. B01D 61/42; C25B 15/00

(52) U.S. Cl. 204/450

(57) ABSTRACT

Methods of performing separations in microfluidic devices are provided. The methods include the use of pressure to introduce reagents into the device, mix the reagents or react the reagents, and the use of electrokinetic forces to separate the reagents or products. To achieve improved separation efficiency, the depths of the various microfluidic channels are varied. The pressure driven channels provided are deep in comparison to the separation channels in which flow is electrokinetically driven. Also included are microfluidic devices and integrated systems for performing separations in which pressure driven flow and electrokinetic driven flow are integrated.

### CROSS-REFERENCES TO RELATED APPLICATIONS

Pursuant to 35 USC § 119 and § 120, and any other applicable statute or rule, this application is a divisional of U.S. Ser. No. 09/696,749, filed Oct. 24, 2000 which claims the benefit of and priority from U.S. Ser. No. 60/161,710, filed Oct. 27, 1999, the disclosure of which is incorporated by reference.

### BACKGROUND OF THE INVENTION

When carrying out chemical or biochemical analyses, assays, syntheses, or preparations, one performs a large number of separate manipulations on the material or component to be assayed, including measuring, aliquotting, transferring, diluting, mixing, separating, detecting, etc. Microfluidic technology miniaturizes these manipulations and integrates them so that they can be performed within one or a few microfluidic devices. For example, separations are often performed in the same device as reactions.

When performing manipulations in microfluidic devices, various types of fluid transport are employed to flow the materials from one area of the device to another, e.g., to dilute a sample in one location and then to react the diluted sample with a reagent in another location, and then detection of the reaction products, e.g., in a detection region. Materials are typically flowed in microscale systems by application of electrokinetic forces or by the application of fluid pressure.

Pressure forces are applied to microfluidic elements to achieve fluid flow using a variety of related techniques, such as fluid displacement, vacuum pump, or the like, to raise or lower the pressure at a site in the system. Electrokinetic forces move fluid through a microfluidic device by the application of an electrical field to the materials in the device. Cations flow toward a negative electrode and anions flow toward a positive electrode. Use of electrokinetic forces to flow fluid through a microfluidic channel was described in pioneering published application WO 96/04547, by Ramsey.

The electrokinetic forces used to separate materials in microfluidic devices are typically electrophoretic forces. Electrophoretic movement relies upon the electrophoretic mobility of charged species within the electric field applied to the material. Electrophoretic movement is used to separate mixtures of components as they move through a microfluidic channel. For example, electrophoretic separation of substrate and product in an enzyme assay allows for simple observation of the reaction time course and easy quantitation of the extent of conversion. Peak area of substrates and products is used to assess the extent of conversion, reaction rate constants, inhibitory constants, and a variety of other chemical and biochemical parameters.

Just as in traditional capillary electrophoresis, electrokinetic sample introduction in a microfluidic device biases sample introduction. The electric fields can cause preferential movement of reagents due to differences in their mass to charge ratio, e.g., highly charged materials move to the front or back of a fluid plug. This effect is undesirable when mixing and reacting various reagents, but is desirable when attempting to electrokinetically separate various compounds.

Therefore, a pressure based system is useful for introducing and transporting samples through a microfluidic system, even when electrokinetic forces are used to separate the samples into their various components. However, pressure based flow often leads to parabolic velocity profiles of reagents in solution. Slower movement of material at channel walls and faster movement of material in the center of the channel is a function of the frictional forces' dependence on channel cross section. Parabolic flow decreases separation resolution due to increased peak width.

The present invention provides improved microfluidic separations in systems that incorporate pressure driven sample introduction and separations based on electrokinetic forces. The methods and devices of the present invention provide these features and many others that will be apparent upon complete review of the following disclosure.

### SUMMARY OF THE INVENTION

The present invention provides methods and devices for separating mixtures of components in microfluidic systems. The methods provide improved integration of electrokinetic separation with pressure induced reagent introduction. For example a vacuum source is optionally used to introduce a sample into a deep channel of the device. The sample is then separated into its various components in a channel under electrokinetic fluid control, e.g., in an electrophoretic separation matrix.

The devices of the invention provide for the integration of pressure and electrokinetic flow control by incorporating a double-depth channel design. Samples are introduced into a deep channel and then separated in a channel that is shallow in comparison to the deep channel. The change in depth between the channels provides for improved fluid control, which leads to better resolution in separations.

Microfluidic devices, comprising a body structure and a plurality of microscale channels disposed therein, are provided. For improved separation resolution, the plurality of channels includes a deep channel and a shallow channel fluidly coupled to the deep channel. Depth and shallowness are determined relative to each other. For example, the cross-sectional area of a deep channel is larger than the cross-sectional area of a shallow channel. Typical dimensions vary, but generally a deep channel, e.g., a mixing or reacting channel, has a depth between about 10 μm and about 20 μm and a width between about 30 μm and about 50 μm. More typically, the depth is about 15 μm and the width is about 40 μm. The shallow channels, e.g., separation or loading channels, typically have a depth between about 1 μm and about 10 μm and a width between about 5 μm and about 15 μm. More typically, the shallow channels have a depth of about 3 μm and a width of about 9 μm.

The deep channel(s) is used for introducing samples into the device, for mixing samples with reagents, and for reacting samples, e.g., to perform an enzyme assay. The shallow channels are used for separations, e.g., for electrophoretically separating the sample into its various components or for separating substrates from products in an enzyme assay. In some embodiments, the shallow separation channel includes a separation matrix. Matrix materials include, but are not limited to, polyacrylamide gels and polydimethylacrylamide/co-acrylic acid polymer solutions. Shallow channels are also used for loading samples, e.g., from a deep mixing channel or a deep reaction channel, into a separation channel. A shallow loading channel used to load a sample into a separation channel typically intersects the separation channel and is fluidly coupled to a deep mixing channel or deep reaction channel.

In other embodiments, the microfluidic devices of the present invention include a pressure source in fluid communication with one or more of the deep channels. The pressure source introduces one or more samples into a deep channel, e.g., an introduction, mixing, or reaction channel, by applying pressure to the fluid in the deep channel. The pressure source also transports samples through the mixing or reaction channel.

The pressure sources of the invention optionally apply a positive pressure or a negative pressure. For example, the pressure source optionally comprises a vacuum or a siphon. In other embodiments, an electroosmotic pump fluidly coupled to a deep channel is used to induce pressure in the deep channel. The electroosmotic pump comprises a channel containing a fluidic material, which typically comprises a salt.

The devices also optionally include an electrokinetic controller in fluid communication with one or more shallow channels, e.g., separation or loading channels. The electrokinetic controller transports one or more samples through a shallow separation channel by applying a voltage to the shallow separation channel. The electrokinetic controller is also optionally used to load one or more samples from a deep channel into a separation channel or from a shallow loading channel into a separation channel.

In another aspect, the present invention provides methods of performing separations in the devices described above. Separations are performed on various samples comprising mixtures of components. In one embodiment, the method comprises flowing at least a first sample through a deep mixing channel by applying pressure to the first sample in the deep mixing channel. The next step in the method comprises flowing the first sample into a shallow separation channel by applying an electrokinetic force to the first sample. In the shallow separation channel at least two components of the first sample are electrokinetically separated.

In some embodiments, the method includes electrokinetically loading the first sample from the deep mixing channel into a shallow loading channel and electrokinetically injecting the first sample from the shallow loading channel into the shallow separation channel.

In some embodiments, a second sample is optionally introduced into the deep mixing channel concurrent with loading a first sample into a shallow loading channel or electrokinetically separating a first sample. In other embodiments, reduced pressure or substantially no pressure is applied to the deep channels during the separating step.

The samples separated in the present methods are optionally reacted with one or more reagents before or after the separation. The reaction is typically carried out in one of the deep channels, e.g., a deep mixing channel or a deep reaction channel. For example, an enzyme reaction is optionally conducted using the methods and devices of the present invention. In an enzyme assay, the sample typically comprises a modulator, e.g., an inhibitor or activator. The reagents added to the reaction typically comprise an enzyme and a substrate. The substrate and enzyme are reacted in a deep channel, in the presence of the modulator, e.g., to produce a product. The product is typically separated from the substrate in a shallow separation channel using the methods of the invention. The amount of product and substrate are then optionally quantitated.

### BRIEF DESCRIPTION OF THE DRAWINGS

FIG. 1: A schematic illustration of a vacuum pumped microfluidic device with a shallow loading channel and a shallow separation channel, for use in performing separations.

FIG. 2: A schematic of a microfluidic device comprising an electroosmotic pump and both shallow loading and shallow separation channels, for use in performing separations.

FIG. 3: Schematic of various devices useful for performing separations by the present methods. Layer two, the top layer, which shows both shallow and deep channels, is shown here. Device A comprises a vacuum pumped device with a separation channel only. Device B, which comprises a vacuum pumped device with both load and separation channels, is also shown in FIG. 1. Device C comprises an electroosmotically pumped device with separation channel only. Device D shows an electroosmotically pumped device with load and separation channels and is also pictured in FIG. 2. Device E shows an electroosmotically pumped device with load and separation channels and a second pump for sample injection.

FIG. 4: Layer one of the devices shown in FIG. 3. Layer one shows the deep channels or channel regions only.

FIG. 5: Pressure driven reagent introduction with electrophoretic separation during pumping. Panel A shows the separation of Bodipy-Fl-Arginine and Fl-Kemptide using the channel configuration shown in FIG. 1. Panel B is a magnified view demonstrating baseline separation.

FIG. 6: Pressure driven reagent introduction with electrophoretic separation during pumping. Panel A shows separation of the substrate and product in a PKA assay using the channel configuration shown in FIG. 1. Panel B provides a magnified view demonstrating baseline separation.

FIG. 7: Integrated electroosmotic pump to introduce reagents for electrophoretic separation. Panel A shows the separation of rhodamine B and rhodamine 6G using the channel configuration shown in FIG. 2. Panel B provides a magnified view, demonstrating baseline separation.

FIG. 8: Integrated electroosmotic pump to introduce reagents for electrophoretic separation. Panel A shows the separation of substrate and product in a PKA reaction using the channel configuration shown in FIG. 2. Panel B provides a magnified view demonstrating baseline separation.

FIG. 9: Alternative channel configurations for devices of the invention.

FIG. 10: Results for an electrophoretic separation with pressure driven sample introduction with a 10 second duty cycle using the channel configuration shown in FIG. 1. The results indicate that baseline separation is achieved and that separations in the shallow separation channel are impervious to pressure fluctuations in the deep channel.

FIG. 11: Panels A, B, and C are schematic drawings of an integrated system of the invention, including a body structure, microfabricated elements, and a pipettor channel.

FIG. 12: Schematic drawing of an integrated system of the invention further depicting incorporation of a microwell plate, a computer, detector and a fluid direction system. The integrated system is optionally used with either the devices or body structures of FIG. 1, 2, 3, 9, or any other suitable microfluidic device.

### DETAILED DISCUSSION OF THE INVENTION

The present invention provides new methods of sample loading and obtaining baseline separation of components in a microfluidic system that integrates pressure driven flow with electrokinetic separation techniques. The samples or components are introduced into the system and optionally mixed and/or reacted with other reagents using pressure induced flow and then separated via electrophoresis.

The successful integration of electrophoretic flow control with pressure driven introduction of reagents eliminates electrokinetic bias and simplifies movement of reagents into a reaction channel as compared to a system under electrokinetic control alone. Highly charged species driven through a channel by electrokinetic forces will move faster or slower than the other components and begin to separate in the reaction channels. The present invention provides a system in which components are separated electrokinetically but are introduced into and transported through reaction or mixing channels without any electrokinetic bias.

In the present system, pressure-based flow is used to introduce the compounds into the system and to mix and/or react them. Therefore, no electric field is applied to those channels and no electrophoretic bias occurs.

Another advantage provided by the present methods is that they are easily adaptable to high-throughput systems in which a capillary is used to sip compounds under pressure from a microtiter plate. Therefore, improved separation resolution can be obtained in high throughput systems using the devices and methods of the present invention.

The above advantages are obtained in the present device by using a system of alternating depth channels. Deep channels provide less hydrodynamic resistance to pressure driven fluid flow and are therefore useful for mixing and reacting reagents and moving reagents through a device. Shallow channels provide more resistance to pressure driven flow. Deep channels are used when pressure-induced flow is desired and shallow channels are used when electrokinetic flow is desired. This channel configuration provides successful introduction of samples from, e.g., an external sample well, such as a microtiter plate, to a microfluidic device by application of pressure, electrophoretic loading of samples into a loading channel that intersects a separation channel, and separation of the sample with baseline resolved peaks.

### I. Microfluidic Devices Useful in Performing Separations

The microfluidic devices of the present invention are used to integrate pressure induced reagent introduction with electrokinetic separation. For example, the devices are used to carry out reactions or assays, e.g., enzymatic assays, and then to electrokinetically separate the products of the reaction or assay, e.g., separation of the product of an enzyme reaction from the substrate. The present devices are configured to control fluid flow and provide baseline separation of the resulting peaks, e.g., product and substrate peaks.

The devices generally comprise a body structure with microscale channels fabricated therein. For example, the present system comprises, e.g., a deep mixing channel and a shallow separation channel. The sizes of the channels are configured to provide good resolution for separations performed in the shallow separation channel. The double depth channel configurations of the present invention control flow in the devices, eliminate electrokinetic bias in the mixing channels, and eliminate or minimize parabolic flow in the electrokinetically controlled channels. Deep channels are used for pressure driven flow, which allows sample introduction, mixing and reacting free from electrokinetic bias. Shallow channels are used for electrokinetic flow. Because the resistance to hydrodynamic flow is proportional to one over the channel height cubed, a shallow channel allows for an uncoupling of the electrokinetic flow from the pressure flow. This decreases the contribution of parabolic flow to electrokinetic separations. Thus, clean baseline resolved separation is easily obtained without the complication due to superimposing a parabolic head on the reagent plug's velocity profile in the electrokinetic separation.

The deep and shallow channels are fluidly coupled to each other and to various reservoirs or other sources of materials. In addition, the channels optionally comprise additional channels and/or regions, such as a loading channel and/or a detection region.

Materials used in the present invention include, but are not limited to, samples, reagents, buffers, and the like. These materials are transported through the various depth channels of the device using pressure-based flow or electrokinetic flow. The different channel depths are configured in the present invention to get the best advantages from both types of flow.

Resistance to channel flow is proportional to one over the channel height cubed (R∞(1/h)³). Therefore, shallow channels are preferred when maximum resistance to flow is desired, e.g., during separations, and deep channels are preferred when less resistance is desired, e.g., during sample mixing and transport. For example, wide deep channels are preferable for reagent introduction and sample mixing because they present low resistance to fluid flow.

In addition, shallow channels minimize parabolic flow, which occurs in pressure driven channels, by minimizing the fluid draw on the channels. Therefore, a shallower channel is preferable for separation because the shallower channel prevents parabolic flow from contributing significantly to the flux in the separation channel.

Furtherrnore, shallow channel dimensions determine the amount of reagent that is injected into the separation channel. The channel dimension thus provides an alternative for control of load volume other than injection timing and pinching currents. For example, a cross-injector for separations in standard dimension channels (e.g., about 70 μm wide by about 20 μm deep) contains more than 400 times the volume at the intersection of two shallow, narrow channels of dimension 9 μm wide by 3 μm deep. A cross-injector that injects material from a standard dimension channel into a standard dimension channel injects more than 50 times the volume of a cross injector that injects fluid from a standard dimension channel into a shallow channel of the invention. When integrating pressure driven flow with electrokinetic separation based assays, the shallow channels allow for the uncoupling of parabolic flow and electrophoretic flow and offer a regime of channel dimensions that provides good separations.

To account for the flow characteristics described above, the channels in the devices of the present invention typically fall into one of two categories. The channels are considered deep channels or shallow channels. A “deep channel” in the present invention refers to a channel with a physical channel dimension, typically channel height or a cross-sectional area, that is larger than a “shallow channel” of the invention. The terms “deep” and “shallow” are used relative to each other. The deep channels have a larger cross-sectional area than the shallow channels. For example, the deep channels of the invention are typically at least about two times as deep as the shallow channels, preferably at least about 5 times as deep as the shallow channels, and often at least about 10 times as deep as the shallow channels. In addition, the deep channels are typically at least about 2 times as wide as the shallow channels, preferably at least about 4 times as wide as the shallow channels and often at least about 5 to about 10 times as wide as the shallow channels. Examples of devices incorporating deep and shallow channels are described in WO 98/00705 and U.S. Pat. No. 5,842,787 and U.S. Pat. No. 5,957,579, each of which is incorporated herein by reference.

Typically, the depth of a deep channel ranges from about 5 μm to about 100 μm, preferably from about 10 μm to about 50 μm, and more preferably from about 10 μm to about 20 μm. The width of the deep channels is typically from about 5 μm to about 100 μm, preferably from about 20 μm to about 50 μm, and more preferably the deep channels are about 35 μm wide to about 45 μm wide. For example, a typical deep channel has a depth of 15 μm and a width of 40 μm.

The shallow channels have smaller depths and widths than the deep channels. For example, the shallow channels of the present invention typically have a depth ranging from about 1 μm to about 20 μm. Preferably the depth of the shallow channels ranges from about 1 μm to about 15 μm, and more preferably from about 3 μm to about 10 μm. The width of the shallow channels is typically between about 1 μm and about 20 μm, preferably between about 5 μm and about 15 μm, and more preferably between about 5 μm and about 10 μm. For example a typical shallow channels has a depth of about 3 μm and a width of about 9 μm.

In addition to the size distinction between the deep channels and the shallow channels, the channels are also generally distinguished by the method of flow control used within the channel and by the function of the channels. Pressure induced flow typically transports materials through the deep channels of the invention and electrokinetic forces, e.g., electroosmotic and/or electrophoretic, control the flow of materials in the shallow channels. Mixing and reacting of reagents typically occur in the deep channels and separations generally occur in the shallow channels.

Typically, the deep channels are used in situations where pressure driven fluid flow is desired. For example, when introducing a sample or reagent into a device, a sipper capillary is optionally used, e.g., in high throughput systems. A deep channel used to introduce, e.g., a sample or reagent, into a device is an introduction channel. Deep channels are also used for mixing reagents and for carrying out reactions between samples and reagents, e.g., enzyme reactions between enzyme and substrate in the presence of a modulator or binding reactions between a receptor and a ligand. Resistance to flow is greater in the shallow channels than in the deep channels; therefore, the deep channels are more appropriate for mixing and reacting samples.

The deep channels of the present invention are typically mixing channels. A mixing channel is typically a channel, channel portion, or region that receives the various reagents, materials, samples, or the like, which are the subject of the desired analysis, or assay. The various reagents of an assay are introduced into the mixing channel, allowed to mix, and then reacted with each other or other reagents. Therefore, the deep mixing channel of the present invention is optionally a deep introduction channel or a deep reaction channel. Although preferably used for fluid based reactions and analyses, it will be readily appreciated that the mixing channel optionally includes immobilized reagents disposed therein, e.g., immobilized on the surface of the channel or upon a solid support disposed within the channel. The mixing channel is typically fluidly connected at one end to a source of at least one reagent or sample. A second end of the mixing channel is typically connected to a shallow loading channel or shallow separation channel, in which the products of mixing or reacting are further analyzed, or to another reagent reservoir or waste reservoir, in which the reactants are discarded at the conclusion of the assay.

The shallow channels of the invention are used when electrokinetic flow control is desired. For example, when separating a mixture of components, electrophoresis is typically used to separate the components based on mass/charge ratio. Therefore, an electrokinetic, e.g., electrophoretic, control element is required. Additionally, a shallow channel is optionally used to transfer components from a deep mixing channel or deep reaction channel into a shallow separation channel. The shallow channels minimize the draw on the loading and/or separation channels thereby decreasing the contribution of parabolic flow to the variance or peak width obtained in the separations.

The shallow channels of the invention are typically shallow separation channels in which mixtures of components are separated into their various components. For example, a mixture of proteins as it flows through a shallow separation channel or separation region will be separated into its component proteins. Optionally, the separation channel is a gel filled channel, e.g., a linear polyacrylamide gel filled channel or a polymer solution filled channel, e.g., a polyacrylamide polymer solution or a polydimethylacrylamide/co-acrylic acid polymer, that separates the various components, e.g., based on molecular weight, wherein each component is eluted from the separation channel with a different retention time. The components are then optionally detected and their molecular weights determined by the retention time.

In other embodiments, samples are also reacted with one or more reagents once they reach a shallow separation channel or shallow loading channel. These reagents optionally comprise an alternate buffer formulation comprising a flow stream and/or an additive to the flow stream.

A shallow loading channel is also optionally included in the microfluidic devices and systems in the present invention. A shallow loading channel typically intersects a shallow separation channel and a deep channel. Materials are electrokinetically loaded from a deep channel, e.g., a deep mixing channel, into the shallow loading channel and then electrokinetically injected into a shallow separation channel. For example, a cross-injection from a shallow loading channel into a shallow separation channel injects the volume of fluid at the intersection of the shallow loading channel and the shallow separation channel into the shallow separation channel. Alternatively, loading occurs directly from a deep channel into a shallow channel through a gated or cross injection.

Reservoirs, e.g., for storing, discarding, or supplying, samples, reagents, buffers, and the like, are also optionally included in the devices of the present invention. For example, a reservoir for a binding buffer or a sample well is optionally located at one end of a deep mixing channel for introduction of the sample into the deep mixing channel. The reservoirs are the locations or wells at which samples, components, reagents and the like are added into the device for assays to take place. Introduction of these elements into the system is carried out as described below.

Pressure sources are also optionally applied at the reservoirs of the invention. Typically deep channels connect the reservoirs to a pump or other pressure source. For example a vacuum source may be fluidly coupled to the device at a waste reservoir located at the end of a deep mixing channel. The vacuum source draws fluid into the deep mixing channel for mixing or reacting with other reagents. Additionally, the vacuum optionally draws any excess or unused material, e.g., material not loaded into a shallow loaded channel, into the waste reservoir to which the vacuum source is fluidly coupled. Alternatively, a positive pressure source is fluidly coupled to a sample well or reservoir at one end of a deep mixing channel. The pressure then forces the material into and through the deep mixing channel.

Electrokinetic forces, e.g., high or low voltages or currents, are also optionally applied at reservoirs to the materials in the channels. For example, voltage gradients applied across the separation channel are used to move fluid down the channel, thus separating the components of the material as they move through the channel at different rates.

While electrokinetic forces, e.g., electrophoretic or electroosmotic forces, typically drive fluid flow in the shallow channels of the inventions, fluid flow in the deep channels is typically pressure driven. The pressure is optionally induced by the application of a pressure source to the fluid in the deep channels. For example, a vacuum source fluidly coupled to a reservoir or deep channel is optionally applied to induce a pressure differential along the length of the channel and draw fluid into the channel.

An alternative way to induce pressure driven flow in the deep channels comprises the application of an electroosmotic pump. Electroosmotic pumps are described by Parce in “Micropump,” WO 99/16162. Typically an electroosmotic pump comprises two channels. The pump utilizes electroosmotic pumping of fluid in one channel or region to generate pressure based fluid flow in a connected channel, where the connected channel has substantially no electroosmotic flow generated within it. For example, an electrokinetic controller applies a voltage gradient to one channel to produce electroosmotically-induced pressure within that channel. That pressure is transmitted to a second channel whereupon pressure based flow is achieved. Typically, the channels used for propagating electroosmotic flow have smaller cross-sectional areas than the deep channels of the invention. These pumps are particularly useful in situations in which application of an electric field to the channel is not desired or where pressure based flow is particularly desirable, e.g., for cell based assays or for introducing, mixing, or reacting materials.

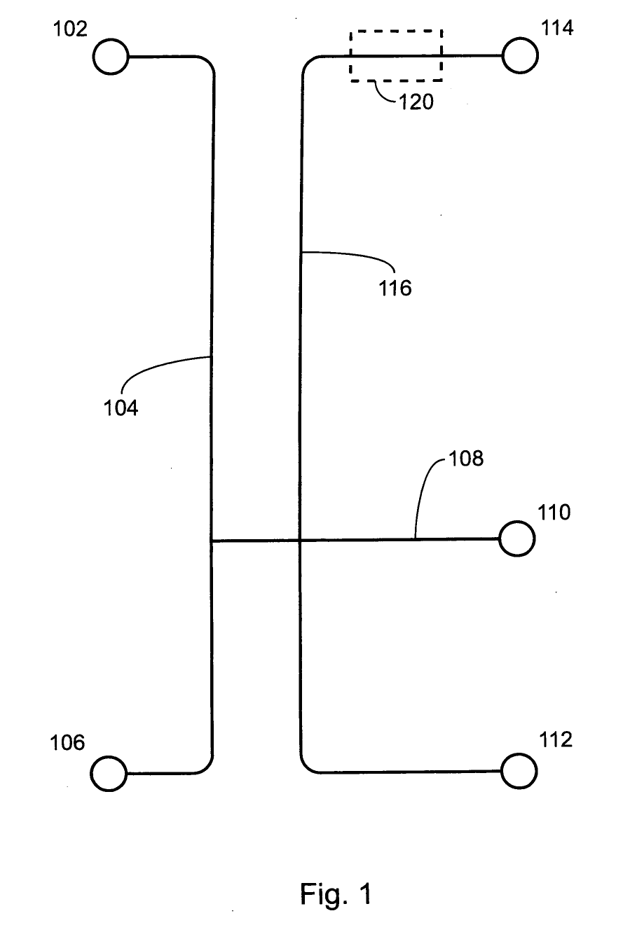

Detection regions are also included in the present devices. The detection region is optionally a subunit of a channel, such as detection region 120 in FIG. 1. Alternatively, the detection region optionally comprises a distinct channel that is fluidly coupled to the plurality of channels in the microfluidic device. For example, a channel is optionally positioned intersecting shallow separation channel 116 in FIG. 1 to serve as a detection channel. The detection region is optionally located anywhere along the length of the separation channel or region. For example, a detection region located at the most downstream point or end of a shallow separation channel detects the separated components as they exit the shallow separation channel. In other embodiments, the detection region is optionally located at the downstream end of the device just upstream from a waste well.

The detection window or region at which a signal is monitored typically includes a transparent cover allowing visual or optical observation and detection of the assay results, e.g., observation of a colorimetric or fluorometric signal or label. Examples of suitable detectors are well known to those of skill in the art and are discussed in more detail below.

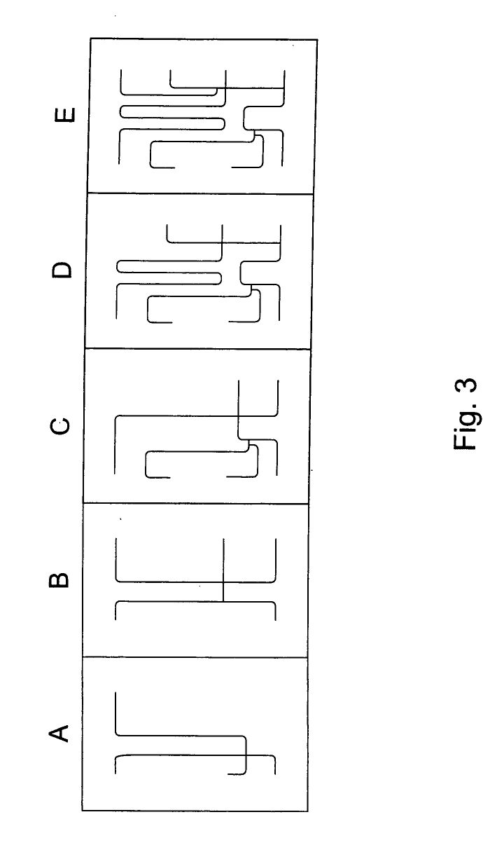

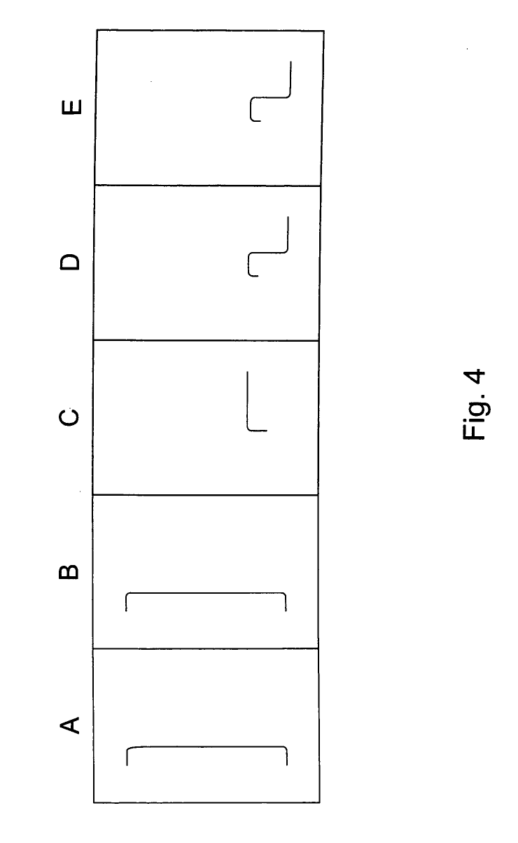

One embodiment of the present system is illustrated in FIG. 1. As shown, the system comprises reservoir 102, which is optionally used to introduce a sample into the system. From reservoir 102, a sample is then directed into deep mixing channel 104. In deep mixing channel 104 the sample is optionally mixed with a diluent or a buffer or reacted with other reagents, e.g., a substrate and enzyme. Fluid flow in deep reaction channel 104 is typically controlled by a pressure source, e.g., a pressure source fluidly coupled to either reservoir 102 or waste reservoir 106. For example, a vacuum source is optionally coupled to waste reservoir 106. From deep mixing channel 104, the sample, e.g., a mixed and/or reacted sample or product is typically directed via an electrokinetic controller into shallow loading channel 108. For example, voltages are optionally applied at reservoirs 110 and 106 to electrokinetically transport material from deep mixing channel 104 to shallow loading channel 108. From shallow loading channel 108, the sample is injected into shallow separation channel 116. For example, a cross injection using voltages at reservoirs 112 and 114 injects the volume of fluid at the intersection of shallow loading channel 108 and shallow separation channel 116 into shallow separation channel 116. Alternatively, the channel configuration of Device A in FIG. 3A (showing both shallow and deep channels) is used and the sample and/or product is optionally cross injected from the deep mixing channel directly into the shallow separation channel. FIG. 4A indicates which of the channels in FIG. 3A comprise deep channels. In shallow separation channel 116, a mixture of components, e.g., of proteins, is typically separated, e.g., by electrophoresis. A detector is optionally positioned proximal to reservoir 114 or proximal to the downstream end of shallow separation channel 116 to detect the components as they elute from shallow separation channel 116, e.g., at detection window 120. When the assay and detection are complete, the sample components are optionally directed to reservoir 114 for disposal or retrieval. Any of the reservoirs, e.g., 102, 106, 112, 110, and 114 are optionally used as waste wells.

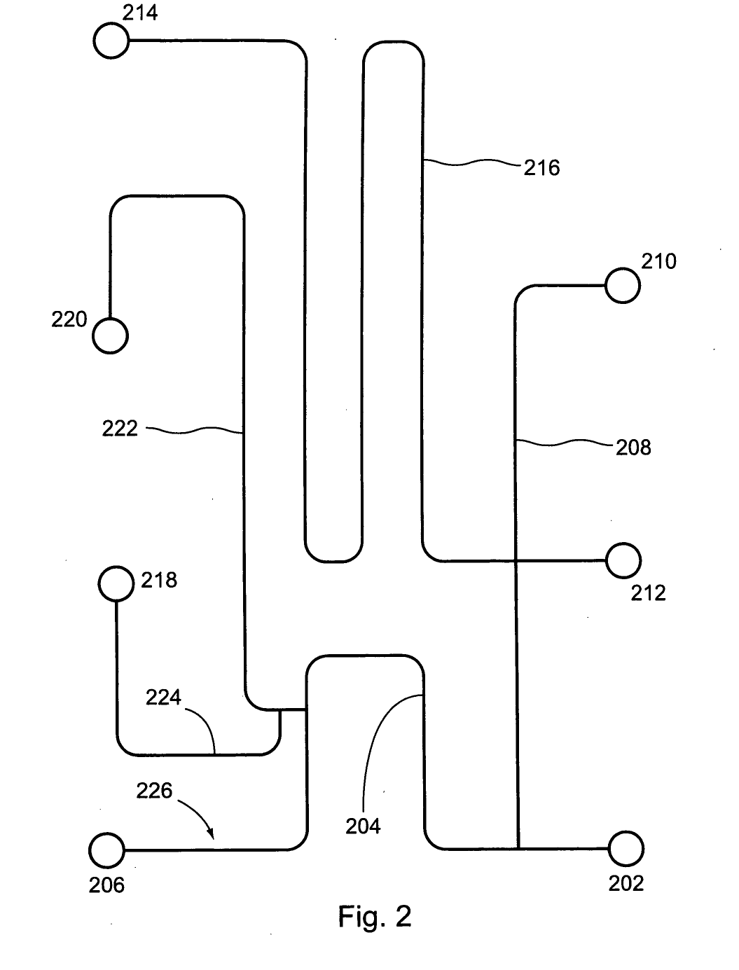

In an alternate embodiment of the present invention, an electroosmotic pump is used to introduce pressure-based flow in the deep channel, e.g., a deep mixing channel or deep reaction channel. FIG. 2 provides a schematic illustration of an electroosmotic pump incorporated into a microfluidic device of the present invention. The plurality of channels disposed within the device comprises a combination of deep and shallow channels as described below. A sample is optionally introduced into the device through sample well 202 and is drawn into deep mixing channel 204 by the action of an electroosmotic pump. The electroosmotic pump comprises shallow pump channel 222, which is optionally a long, shallow salt-filled channel. This channel extends from reservoir 220 to the end of deep mixing channel 204. Channel region 224, which forms an additional shallow arm on the pump to reservoir 218, is used to draw salt solution from reservoir 220 almost to the intersection of shallow pump channel 222 and deep mixing channel 204. This arm prevents contamination of other parts of the channel network with the salt solution. The pump uses electroosmotic flow to induce pressure in deep mixing channel 204, thus drawing the sample into deep mixing channel 204. Substantially no electroosmotic flow is generated in deep mixing channel 204 due to the electroosmotic pump. Therefore, the sample in deep mixing channel 204 is introduced into the system by pressure-induced flow. The sample in deep mixing channel 204 is optionally reacted with other reagents, which are optionally introduced into the device through reservoirs 202, 206, e.g., via channel region 226, and the like. The mixed sample and/or reacted product, e.g., leftover substrate and reacted product in an enzyme assay, is then optionally electrokinetically loaded into shallow loading channel 208. For example a voltage difference between reservoir 210 and reservoir 206 or 202 is optionally used to load the sample into shallow loading channel 208. The sample is then injected into shallow separation channel 216. For example, the sample is cross- injected from shallow loading channel 208 into shallow separation channel 216 by a voltage difference between reservoir 212 and reservoir 214. Alternatively, the sample or product is directly injected into the shallow separation channel from the deep mixing channel using a channel configuration like that of Device C in FIG. 3 (Deep channels are indicted by FIG. 4C). Shallow separation channel 216 is optionally a long serpentine channel to accommodate lengthy separation times. Within shallow separation channel 216, the sample is electrokinetically separated into its components. For example, a substrate is electrophoretically separated from a product. The sample or products are optionally detected upon separation. A detector is optionally placed proximal to a detection region. Detection regions are optionally located anywhere along the length of shallow separation channel 216.

FIGS. 1 and 2 provide two examples of the devices of the invention. In these examples, the deep channels, e.g., deep mixing channels 104 and 204, are about 15 μm deep and about 40 μm wide. The shallow channels, e.g., shallow loading channels 108 and 208 and shallow separation channels 116 and 216 are about 3 μm deep and about 9μm wide.

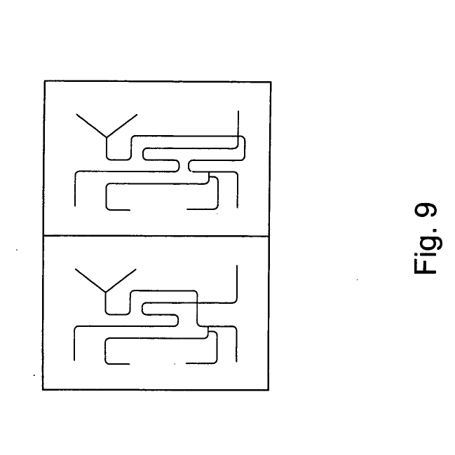

The channel dimensions given above are examples of possible dimensions. However, it is possible to fabricate mixing channels of a broad range of dimensions for facilitating pressure-induced flow in combination with electrokinetic flow. The mixing channels typically intersect the separation channels directly or first feed into a loading channel that intersects the separation channel. Various configurations and dimensions are possible to accommodate the fluid flow described herein. For example, the loading channel and separation channel are optionally as small as 1 μm deep and 5 μm wide. Other possible channel configurations include, but are not limited to, those provided in FIGS. 3 and 4 and 9.

Microfluidic Systems in General

A variety of microscale systems are optionally adapted to the present invention by incorporating varied channels depths, e.g., deep mixing channels and shallow separation channels, separations gels, particle sets, enzymes, substrates, and the like. Microfluidic devices which can be adapted to the present invention by the addition of alternating depth channels and appropriately configured pressure and electrokinetic control elements are described in various PCT applications and issued U.S. Patents by the inventors and their coworkers, including U.S. Pat. No. 5,699,157 (J. Wallace Parce) issued Dec. 16, 1997, U.S. Pat. No. 5,779,868 (J. Wallace Parce et al.) issued Jul. 14, 1998, U.S. Pat. No. 5,800,690 (Calvin Y. H. Chow et al.) issued Sep. 1, 1998, U.S. Pat. No. 5,842,787 (Anne R. Kopf-Sill et al.) issued Dec. 1, 1998, U.S. Pat. No. 5,852,495 (J. Wallace Parce) issued Dec. 22, 1998, U.S. Pat. No. 5,869,004 (J. Wallace Parce et al.) issued Feb. 9, 1999, U.S. Pat. No. 5,876,675 (Colin B. Kennedy) issued Mar. 2, 1999, U.S. Pat. No. 5,880,071 (J. Wallace Parce et al.) issued Mar. 9, 1999, U.S. Pat. No. 5,882,465 (Richard J. McReynolds) issued Mar. 16, 1999, U.S. Pat. No. 5,885,470 (J. Wallace Parce et al.) issued Mar. 23, 1999, U.S. Pat. No. 5,942,443 (J. Wallace Parce et al.) issued Aug. 24, 1999, U.S. Pat. No. 5,948,227 (Robert S. Dubrow) issued Sep. 7, 1999, U.S. Pat. No. 5,955,028 (Calvin Y. H. Chow) issued Sep. 21, 1999, U.S. Pat. Nos. 5,957,579 (Anne R. Kopf-Sill et al.) issued Sep. 28, 1999, U.S. Pat. No. 5,958,203 (J. Wallace Parce et al.) issued Sep. 28, 1999, U.S. Pat. No. 5,958,694 (Theo T. Nikiforov) issued Sep. 28, 1999, and U.S. Pat. No. 5,959,291 (Morten J. Jensen) issued Sep. 28, 1999; and published PCT applications, such as, WO 98/00231, WO 98/00705, WO 98/00707, WO 98/02728, WO 98/05424, WO 98/22811, WO 98/45481, WO 98/45929, WO 98/46438, and WO 98/49548, WO 98/55852, WO 98/56505, WO 98/56956, WO 99/00649, WO 99/10735, WO 99/12016, WO 99/16162, WO 99/19056, WO 99/19516, WO 99/29497, WO 99/31495, WO 99/34205, WO 99/43432, and WO 99/44217.

For example, pioneering technology providing cell based microscale assays are set forth in U.S. Pat. No. 5,942,443, by Parce et al. “High Throughput Screening Assay Systems in Microscale Fluidic Devices” and, e.g., in 60/128,643 filed Apr. 4, 1999 and 09/510,626 filed Feb. 22, 2000, both entitled “Manipulation of Microparticles In Microfluidic Systems,” by Mehta et al. Complete integrated systems with fluid handling, signal detection, sample storage and sample accessing are available. For example, U.S. Pat. No. 5,942,443 provides pioneering technology for the integration of microfluidics and sample selection and manipulation.

In general, enzymes, cells, modulators and other components can be flowed in a microscale system by electrokinetic (including either electroosmotic or electrophoretic) techniques, or using pressure-based flow mechanisms, or combinations thereof. In the present system, a combination of electrokinetic transport and pressure-based transport is typically used. For example, a pressure-based system transports materials through a mixing or reaction channel and electrokinetic transport moves the materials through a separation channel.

Electrokinetic material transport systems or electrokinetic controllers are used in the present invention to provide movement of enzymes, substrates, modulators, and the like, through microfluidic channels. “Electrokinetic material transport systems,” as used herein, include systems that transport and direct materials within a microchannel and/or chamber containing structure, through the application of electrical fields to the materials, thereby causing material movement through and among the channel and/or chambers, i.e., cations will move toward a negative electrode, while anions will move toward a positive electrode. For example, movement of fluids toward or away from a cathode or anode can cause movement of proteins, enzymes, cells, modulators, etc. suspended within the fluid. Similarly, the components, e.g., proteins, antibodies, carbohydrates, etc. can be charged, in which case they will move toward an oppositely charged electrode (indeed, in this case, it is possible to achieve fluid flow in one direction while achieving particle flow in the opposite direction). In this embodiment, the fluid can be immobile or flowing and can comprise a matrix as in electrophoresis. For example, proteins are separated based on mass/charge ratio in a channel comprising a separation matrix, such as polyacrylamide.

Typically, the electrokinetic material transport and direction systems of the invention rely upon the electrophoretic mobility of charged species within the electric field applied to the structure. Such systems are more particularly referred to as electrophoretic material transport systems. For example, in the present system, separation of a mixture of components into its individual components optionally occurs by electrophoretic separation. For electrophoretic applications, the walls of interior channels of the electrokinetic transport system are optionally charged or uncharged. Typical electrokinetic transport systems are made of glass, charged polymers, and uncharged polymers. The interior channels are optionally coated with a material that alters the surface charge of the channel.

A variety of electrokinetic controllers and systems which are optionally used in the present invention are described, e.g., in Ramsey WO 96/04547, Parce et al. WO 98/46438 and Dubrow et al., WO 98/49548, as well as a variety of other references noted herein.

Use of electrokinetic transport to control material movement in interconnected channel structures was described, e.g., in WO 96/04547 and U.S. Pat. No. 5,858,195 by Ramsey. An exemplary controller is described in U.S. Pat. No. 5,800,690. Modulating voltages are concomitantly applied to the various reservoirs to affect a desired fluid flow characteristic, e.g., continuous or discontinuous (e.g., a regularly pulsed field causing the sample to oscillate direction of travel) flow of labeled components in one or more channels toward a waste reservoir. Particularly, modulation of the voltages applied at the various reservoirs, such as reservoirs 214, 212, 210, 202, and the like in FIG. 2, can move and direct fluid flow through the interconnected channel structure of the device.

Other methods of transport are also available for situations in which electrokinetic methods are not desirable. As discussed earlier, sample introduction and reaction are best carried out in a pressure-based system and high throughput systems typically use pressure induced sample introduction. In addition, cells are desirably flowed using pressure-based flow mechanisms.

Pressure based flow is also desirable in systems in which electrokinetic transport is also used. For example, pressure based flow is optionally used for introducing and reacting reagents in a system in which the products are electrophoretically separated. Therefore, in the present invention, pressure-based systems are combined with the electrokinetic transport systems described above.

Pressure can be applied to microscale elements to achieve fluid movement using any of a variety of techniques. Fluid flow (and flow of materials suspended or solubilized within the fluid, including cells or other particles) is optionally regulated by pressure based mechanisms such as those based upon fluid displacement, e.g., using a piston, pressure diaphragm, vacuum pump, probe, or the like to displace liquid and raise or lower the pressure at a site in the microfluidic system. The pressure is optionally pneumatic, e.g., a pressurized gas, or uses hydraulic forces, e.g., pressurized liquid, or alternatively, uses a positive displacement mechanism, i.e., a plunger fitted into a material reservoir, for forcing material through a channel or other conduit, or is a combination of such forces.

In some embodiments, a vacuum source is applied to a reservoir or well at one end of a channel to draw the suspension through the channel. For example, a vacuum source is optionally placed at a reservoir in the present devices for drawing fluid into a channel, e.g., a vacuum source at reservoir 106 in FIG. 1 applies a pressure to deep mixing channel 104, thus drawing fluid from reservoir 102 into deep mixing channel 104.

Pressure or vacuum sources are optionally supplied external to the device or system, e.g., external vacuum or pressure pumps sealably fitted to the inlet or outlet of the channel, or they are internal to the device, e.g., microfabricated pumps integrated into the device and operably linked to the channel. Examples of microfabricated pumps have been widely described in the art. See, e.g., published International Application No. WO 97/02357.

Another alternative to electrokinetic transport is an electroosmotic pump which uses electroosmotic forces to generate pressure based flow. See, e.g., published International Application No. WO 99/16162 by Parce, entitled “Micropump.” An electroosmotic pump typically comprises two channels. The pump utilizes electroosmotic pumping of fluid in one channel or region to generate pressure based fluid flow in a connected channel, where the connected channel has substantially no electroosmotic flow generated. For example, an electrokinetic controller applies a voltage gradient to one channel to produce electroosmotically induced pressure within that channel. That pressure is transmitted to a second channel whereupon pressure based flow is achieved. In the present invention, an electroosmotic pump is optionally used to produce pressure-based flow in the deep mixing channel. The channel surfaces of the pumping channel typically have charged functional groups associated therewith to produce sufficient electroosmotic flow to generate pressure in the channels in which no electroosmotic flow takes place. See WO 99/16162 for appropriate types of functional groups.

Hydrostatic, wicking, and capillary forces are also optionally used to provide pressure for fluid flow of materials such as enzymes, substrates, modulators, or protein mixtures. See, e.g., “METHOD AND APPARATUS FOR CONTINUOUS LIQUID FLOW IN MICROSCALE CHANNELS USING PRESSURE INJECTION, WICKING AND ELECTROKINETIC INJECTION,” by Alajoki et al., U.S. Ser. No. 09/245,627, filed Feb. 5, 1999. In these methods, an absorbent material or branched capillary structure is placed in fluidic contact with a region where pressure is applied, thereby causing fluid to move towards the absorbent material or branched capillary structure. The capillary forces are optionally used in conjunction with the electrokinetic or pressure-based flow in the present invention. The capillary action pulls material through a channel. For example a wick is optionally added to a deep mixing channel to aid fluid flow by drawing liquid through the channel.

Mechanisms for reducing adsorption of materials during fluid-based flow are described in “PREVENTION OF SURFACE ADSORPTION IN MICROCHANNELS BY APPLICATION OF ELECTRIC CURRENT DURING PRESSURE- INDUCED FLOW” U.S. Ser. No. 09/310,027, filed May 11, 1999 by Parce et al. In brief, adsorption of cells, components, proteins, enzymes, and other materials to channel walls or other microscale components during pressure-based flow can be reduced by applying an electric field such as an alternating current to the material during flow.

Mechanisms for focusing cells, enzymes, and other components into the center of microscale flow paths, which is useful in increasing assay throughput by regularizing flow velocity, e.g., in pressure based flow, is described in “FOCUSING OF MICROPARTICLES IN MICROFLUIDIC SYSTEMS” by H. Garrett Wada et al., U.S. Ser. No. 09/569,747, filed May 11, 1999. In brief, sample materials are focused into the center of a channel by forcing fluid flow from opposing side channels into the main channel comprising the cells, or by other fluid manipulations.

In an alternate embodiment, microfluidic systems are incorporated into centrifuge rotor devices, which are spun in a centrifuge. Fluids and particles travel through the device due to gravitational and centripetal/centrifugal pressure forces.

The above fluid transport techniques for microfluidic devices are optionally integrated into one device. For example, in the devices of the invention, fluid flow in deep channels is typically pressure driven and fluid flow in shallow channels is typically electrokinetically driven. The channel depths of the devices of the invention are configured to provide improved integration of these techniques, resulting in improved separation resolution.

In addition to transport through the microfluidic system, the invention also provides for introduction of sample or reagents, e.g., enzymes, proteins, substrates, modulators, and the like, into the microfluidic system.

Sources of Assay Components and Integration with Microfluidic Formats

Reservoirs or wells are provided in the present invention as sources of samples, reagents, enzymes, substrates, buffers, and the like. Such wells include, e.g., reservoirs 102, 106, 112, 110, and 114 in FIG. 1. For example, a sample is optionally introduced into the device through reservoir 102.

Sources of samples, mixtures of components, and reagents, e.g., enzymes, substrates, and the like, are fluidly coupled to the microchannels noted herein in any of a variety of ways. In particular, those systems comprising sources of materials set forth in Knapp et al. “Closed Loop Biochemical Analyzers” (WO 98/45481; PCT/US98/06723) and Parce et al. “High Throughput Screening Assay Systems in Microscale Fluidic Devices” WO 98/00231 and, e.g., in Ser. No. 09/510,626 filed Feb. 22, 2000, entitled “Manipulation of Microparticles In Microfluidic Systems,” by Mehta et al. are applicable.

In these systems, a “pipettor channel” (a channel in which components can be moved from a source to a microscale element such as a second channel or reservoir) is temporarily or permanently coupled to a source of material. The source can be internal or external to a microfluidic device comprising the pipettor channel. Example sources include microwell plates, membranes or other solid substrates comprising lyophilized components, wells or reservoirs in the body of the microscale device itself and others.

For example, the source of a sample, component, or buffer can be a microwell plate external to the body structure, having, e.g., at least one well with the selected reagent, test material, or component. Alternatively, a well disposed on the surface of the body structure comprising the sample, component, or reagent, a reservoir disposed within the body structure comprising the sample, component, mixture of components, or reagent; a container external to the body structure comprising at least one compartment comprising the sample, component, or reagent, or a solid phase structure comprising the sample or reagent in lyophilized or otherwise dried form.

A loading channel region is optionally fluidly coupled to a pipettor channel with a port external to the body structure. The loading channel can be coupled to an electropipettor channel with a port external to the body structure, a pressure-based pipettor channel with a port external to the body structure, a pipettor channel with a port internal to the body structure, an internal channel within the body structure fluidly coupled to a well on the surface of the body structure, an internal channel within the body structure fluidly coupled to a well within the body structure, or the like.

The integrated microfluidic systems of the invention optionally include a very wide variety of storage elements for storing samples and reagents to be assessed. These include well plates, matrices, membranes and the like. The reagents are stored in liquids (e.g., in a well on a microtiter plate), or in lyophilized form (e.g., dried on a membrane or in a porous matrix), and can be transported to an array component, region, or channel of the microfluidic device using conventional robotics, or using an electropipettor or pressure pipettor channel fluidly coupled to a region or channel of the microfluidic system.

The above devices, systems, features, and components are used in the methods described below, e.g., to separate a mixture of components, to perform enzyme assays, to separate substrates and products, and the like.

### II. Separation of Components in the Devices of the Invention

The samples, mixtures of components, or substrates and products in the present invention are separated in a shallow separation region or shallow separation channel of the microfluidic devices. A “mixture of components,” as used herein, refers to a combination, known or unknown, of biological components, e.g., proteins, enzymes, carbohydrates, or nucleic acids. The components can be in a complex mixture, such as blood, serum, cell extracts, or in a purified solution, such as a buffered solution of proteins. Typically, the components are separated in the shallow channels of the invention after mixing or reacting in the deep channels.

A sample, e.g., to be assayed, tested, or separated, is introduced into a deep channel of the device, e.g., a deep mixing channel. The deep channel provides minimal resistance to fluid flow as compared to the shallower channels of the present devices. Therefore, the sample is easily flowed through the channel. Due to the use of pressure driven flow in the deep channels, the sample that is introduced has no electrokinetic bias associated with it. No charge is applied to the deep channels; therefore the molecules or components do not move or begin to separate based on charge. Movement of the components is due to the application of pressure, as opposed to the application of charge. Therefore, two components with different charges and masses move in the same direction at substantially the same velocity.

The sample is typically introduced by the application of pressure to the fluid in the reservoir to transport it into the deep mixing channel. The pressure is optionally applied by a vacuum source or other pressure source or by the use of an electroosmotic pump that induces pressure in the deep mixing channels and draws the sample into the deep channel.

After introduction of the sample into the device, the sample is optionally mixed and/or reacted with other reagents. Mixing and/or reacting also occur in the deep channels of the invention. For example, a sample is optionally mixed with a buffer to form a diluted sample. Minimal resistance to fluid flow is desired for complete mixing to occur. In addition, the mixing step is preferably performed free of electrokinetic biasing between differently charged components. Therefore, fluid flow in the deep mixing channels is pressure driven fluid flow. The same is true for reactions carried out in the deep channels of 5 the invention. The reactants are mixed and reacted in the deep channels to minimize resistance to fluid flow and avoid electrokinetic bias. For example, an inhibitor sample is optionally introduced into the device and then mixed with enzyme and substrate, which react to form product. These steps are all carried out in the deep channels of the device.

The product of the reaction is then separated from unreacted substrate. 10 After introduction and/or mixing and reacting, the sample or mixture of components is optionally loaded from the deep mixing channel into a shallow loading channel. The sample material is generally electrokinetically loaded into the shallow loading channel. The shallow loading channel is then used to electrokinetically inject the sample into a shallow separation channel. The shallow loading channel typically intersects a 1 5 shallow separation channel, allowing a cross injection of material from the shallow loading channel to the shallow separation channel. Use of a shallow loading channel with a smaller cross-sectional area than the deep channels of the invention allows the injection of very discrete volumes of samples into the shallow separation channel. When the electroosmotic pump is used, loading of the shallow loading channel optionally occurs simultaneously with 20 electroosmotic pumping of materials into the deep mixing channels. An electroosmotic pump is optionally used during loading of the sample such that sample draw and sample load occur concurrently. Alternatively, the draw and load are performed in series, such that the electroosmotic pump is off whenever the load or injection occurs. The pump is optionally turned off for the following separation step. 25 From the shallow loading channel, the sample is injected into a shallow separation channel. Alternatively, the sample is injected directly from the deep mixing channel into the shallow separation channel for separation of the mixture of components.

Separation of components, e.g., products from substrates, is also performed in the shallow channels of the device. Shallow channels are optionally shallow separation 30 regions or channels, such as shallow separation channel 116 in FIG. 1 or shallow separation channel 216 in FIG. 2. The flat concentration and velocity profile on electrically driven fluid plugs in the shallow channels is favorable over parabolic, pressure driven profiles for fast efficient separation. Therefore, these shallow channels provide improved resolution. In addition, the shallow channels are optionally used to control sample loading because the volume of sample added to a shallow channel is smaller than the volume in the deep channel, therefore the sample more closely resembles a point source at the injection cross used to introduce the sample plug into the separation channel. In addition, electrokinetic forces control fluid flow in the shallow channels. Therefore parabolic flow does not substantially interfere with the separation of the components and reduce resolution.

Typically electrophoretic separation is used to separate the mixture of components in the sample. Electrophoretic separation is the separation of substances achieved by applying an electric field to samples in a solution or gel. In its simplest form, it depends on the different velocities with which the substances or components move in the field. The velocities depend, e.g., on the charge and size of the substances.

The separation channels or regions typically comprise a separation matrix. When the sample is flowed through the separation matrix, the components are separated, e.g., based on physical or chemical properties, such as molecular weight or charge. The separation matrix optionally comprises a polymer, a gel, or a solution.

Preferably, the channel, such as shallow separation channel 116 in FIG. 1, is a polyacrylamide gel filled channel or a polydimethylacrylamide/co-acrylic acid polymer filled channel on which the mixture of components is electrophoretically separated based on charge/mass ratio or molecular weight. Polyacrylamide used as a separation matrix in a microfluidic channel is optionally cross-linked or non-cross-linked. Preferably it is linear polyacrylamide, i.e., polydimethylacrylamide or polydimethylacrylamide/co-acrylic acid. Other polymers include cellulose, agarose, and the like. If the components are detected as they exit the separation region, the components are optionally identified by their retention times.

Other gel electrophoretic media that are optionally placed in a separation channel or region of the invention include silica gels such as Davisil Silica, E. Merck Silica Gel, Sigma -Aldrich Silica Gel (al available from Supelco) in addition to a wide range of silica gels available for various purposes as described in the Aldrich catalogue/handbook (Aldrich Chemical Company, Milwaukee, Wis.). Preferred gel materials include agarose based gels, various forms of acrylamide based gels (reagents available from, e.g., Supelco, SIGMA, Aldrich, Sigma-Aldrich and many other sources), colloidal solutions, such as protein colloids (gelatins) and hydrated starches. For a review of electrophoretic separation techniques and polyacrylamide gels, see, e.g., The Encyclopedia of Molecular Biology, Kendrew (ed.) (1994); and, Gel Electrophoresis of Proteins: A Practical Approach, 2^{nd} edition Hames and Rickwood (Eds.) IRL Press, Oxford England, (1990).

Other types of separation matrices are also optionally used and discussed in U.S. Pat. Application No. 09/093,832 filed Jun. 8, 1998, entitled “Microfluidic Matrix Localizations Apparatus and Methods,” by Mehta and Kopf-Sill. Alternate separation matrix media include low pressure chromatography media, such as non-ionic macroreticular and macroporous resins which adsorb and release components based upon hydrophilic or hydrophobic interactions, e.g., Amberchrom and Amberlite resins (available from Supelco), Dowex, and Duolite (all available from Supelco). Other optional media include affinity media for purification and separation, such as acrylic beads, agarose beads, cellulose, sepharose, or the like. In addition, a wide variety of resins and chromatography media are also available, e.g., from Supelco, Sigma, Aldrich, or the like, for example, biotin resins, dye resins, aluminas, carbopacks, and the like. For a review of chromatography techniques and media, see, e.g., Affinity Chromatography—A Practical Approach, Dean et al., (Eds.) IRL Press, Oxford (1985); and, Chromatographic Methods, 5^{th} Edition, Braithwaite et al., (1996).

For example, a processed protein sample that has been desalted and denatured in SDS is optionally electrophoresed in a linear polyacrylamide gel filled shallow separation channel containing SDS to separate the proteins on the basis of molecular weight of the protein subunits. A detector is optionally positioned so that it detects the proteins that are stained in the gel with a fluorescent protein stain. The retention time of the proteins as they are electrophoresed through the gel is used with markers to measure the molecular weight of the proteins.

By separating the components of the sample in shallow separation channels using the devices and methods of the invention, baseline separation is achieved even when electrokinetic separation is combined with pressure-induced reagent introduction.

### III. Integrated Systems

Although the devices and systems specifically illustrated herein are generally described in terms of the performance of a few or one particular operation, it will be readily appreciated from this disclosure that the flexibility of these systems permits easy integration of additional operations into these devices. For example, the devices and systems described will optionally include structures, reagents and systems for performing virtually any number of operations both upstream and downstream from the operations specifically described herein. Such upstream operations include sample handling and preparation operations, e.g., cell separation, extraction, purification, amplification, cellular activation, labeling reactions, dilution, aliquotting, and the like. Similarly, downstream operations may include similar operations, including, e.g., labeling of components, assays and detection operations, electrokinetic or pressure-based injection of components into contact with particle sets, or materials released from particle sets, or the like.

Instrumentation

In the present invention, materials such as cells, proteins, enzymes, or antibodies are optionally monitored so that a component of interest can be detected or identified or an activity can be determined. For example, after an enzyme assay, the amount of substrate and product is optionally quantitated based on the area of the detected signals. Depending on the detected signal measurements, decisions are optionally made regarding subsequent fluidic operations, e.g., whether to assay a particular component in detail to determine, e.g., kinetic information.

The systems described herein generally include microfluidic devices, as described above, in conjunction with additional instrumentation for controlling fluid transport, flow rate and direction within the devices, detection instrumentation for detecting or sensing results of the operations performed by the system, processors, e.g., computers, for instructing the controlling instrumentation in accordance with preprogrammed instructions, receiving data from the detection instrumentation, and for analyzing, storing and interpreting the data, and providing the data and interpretations in a readily accessible reporting format.

Fluid Direction System

A variety of controlling instrumentation is optionally utilized in conjunction with the microfluidic devices described above, for controlling the transport and direction of fluidic materials and/or materials within the devices of the present invention, e.g., by pressure-based or electrokinetic control. In the present invention both pressure based and electrokinetic fluid control are combined. The invention provides devices and methods for improved separations in devices utilizing both types of flow control.

In the present system, the fluid direction system controls the transport, flow and/or movement of a sample through the microfluidic device. For example, the fluid direction system optionally directs the pressure-based movement of a sample into the device and through a deep mixing channel. The fluid direction system also directs the electrokinetic based movement of the sample from the deep mixing channel into a shallow loading channel, and from the loading channel into a shallow separation channel. Electrokinetic based movement though the shallow separation channel results in separated components.

For example, in the present case fluid transport and direction are controlled in part using pressure based flow systems that incorporate external or internal pressure sources to drive fluid flow. Internal sources include microfabricated pumps, e.g., diaphragm pumps, thermal pumps, lamb wave pumps, and the like that have been described in the art. See, e.g., U.S. Pat. Nos. 5,271,724, 5,277,556, and 5,375,979 and Published PCT Application Nos. WO 94/05414 and WO 97/02357. Preferably, external pressure sources are used, and applied to ports at channel termini. These applied pressures, or vacuums, generate pressure differentials across the lengths of channels to drive fluid flow through them. In the interconnected channel networks described herein, differential flow rates on volumes are optionally accomplished by applying different pressures or vacuums at multiple ports, or preferably, by applying a single vacuum at a common waste port and configuring the various channels with appropriate resistance to yield desired flow rates. Example systems are described in U.S. Ser. No. 09/238,467, filed Jan. 28, 1999.

In an alternate embodiment, the pressure-based flow in the deep channels of the devices is induced and controlled by an electroosmotic pump. The electroosmotic pump is also typically under the direction of the fluid direction system, which applies appropriate voltages to the pumping channels to induce flow in the deep channels.

The electroosmotic pump and other electrokinetic controllers are also controlled by the fluid direction system and used for directing electrokinetic flow in the shallow channels of the invention. For example, the fluid direction system provides fluid transport and direction via electrokinetic controllers applying voltage gradients over the shallow channel lengths, thus inducing movement of fluid and/or particles within the device.

Typically, the controller systems provided are appropriately configured to receive or interface with a microfluidic device or system element as described herein. For example, the controller and/or detector, optionally includes a stage upon which the device of the invention is mounted to facilitate appropriate interfacing between the controller and/or detector and the device. Typically, the stage includes an appropriate mounting/alignment structural element, such as a nesting well, alignment pins and/or holes, asymmetric edge structures (to facilitate proper device alignment), and the like. Many such configurations are described in the references cited herein.

The controlling instrumentation discussed above is also used to provide for electrokinetic injection or withdrawal of material downstream of the region of interest to control an upstream flow rate. The same instrumentation and techniques described above are also utilized to inject a fluid into a downstream port to function as a flow control element.

Detector

Once separated, the components of the sample or product are typically detected. For example, an enzyme reaction product and unreacted substrate that were separated in the shallow separation channel of the invention are typically detected and quantitated. The detector(s) optionally monitors one or a plurality of signals, e.g., from the component of interest in the shallow separation channel. For example, the detector optionally monitors an optical signal that corresponds to a labeled component, such as a labeled substrate or labeled product located in a detection region or detection channel, e.g., a detection region that is proximal to or within the shallow separation channel. In another embodiment, the detector is positioned at the downstream end of the shallow separation region or channel and detects a plurality of signals from the separated components as they elute from the separation matrix.

Proteins, substrates, products, antibodies, or other components which emit a detectable signal, e.g., fluorescein labeled substrates or products, can be flowed past the detector, or, alternatively, the detector can move relative to the array to determine protein position (or, the detector can simultaneously monitor a number of spatial positions corresponding to channel regions, e.g., as in a CCD array).

The detector can include or be operably linked to a computer, e.g., which has software for converting detector signal information into assay result information, e.g., molecular weight based on retention time or elution time, identity of a protein, concentration of a substrate or product, or the like.

Examples of detection systems include optical sensors, temperature sensors, pressure sensors, pH sensors, conductivity sensors, and the like. Each of these types of sensors is readily incorporated into the microfluidic systems described herein. In these systems, such detectors are placed either within or adjacent to the microfluidic device or one or more channels, chambers or conduits of the device, such that the detector is within sensory communication with the device, channel, or chamber. The phrase “proximal,” to a particular element or region, as used herein, generally refers to the placement of the detector in a position such that the detector is capable of detecting the property of the microfluidic device, a portion of the microfluidic device, or the contents of a portion of the microfluidic device, for which that detector was intended. For example, a pH sensor placed in sensory communication with a microscale channel is capable of determining the pH of a fluid disposed in that channel. Similarly, a temperature sensor placed in sensory communication with the body of a microfluidic device is capable of determining the temperature of the device itself.

Particularly preferred detection systems include optical detection systems for detecting an optical property of a material within the channels and/or chambers of the microfluidic devices that are incorporated into the microfluidic systems described herein. For example, fluorescent or chemiluminescent detectors are typically preferred. Such optical detection systems are typically placed adjacent to a microscale channel of a microfluidic device, and are in sensory communication with the channel via an optical detection window that is disposed across the channel or chamber of the device. Optical detection systems include systems that are capable of measuring the light emitted from material within the channel, the transmissivity or absorbance of the material, as well as the material's spectral characteristics. In preferred aspects, the detector measures an amount of light emitted from the material, such as a fluorescent or chemiluminescent material. As such, the detection system will typically include collection optics for gathering a light based signal transmitted through the detection window, and transmitting that signal to an appropriate light detector. Microscope objectives of varying power, field diameter, and focal length are readily utilized as at least a portion of this optical train. The light detectors are optionally photodiodes, avalanche photodiodes, photomultiplier tubes, diode arrays, or in some cases, imaging systems, such as charged coupled devices (CCDs) and the like. In preferred aspects, photodiodes are utilized, at least in part, as the light detectors. The detection system is typically coupled to a computer (described in greater detail below), via an analog to digital or digital to analog converter, for transmitting detected light data to the computer for analysis, storage and data manipulation.

In the case of fluorescent materials such as labeled cells, the detector typically includes a light source which produces light at an appropriate wavelength for activating the fluorescent material, as well as optics for directing the light source through the detection window to the material contained in the channel or chamber. The light source can be any number of light sources that provides an appropriate wavelength, including lasers, laser diodes and LEDs. Other light sources are required for other detection systems. For example, broad band light sources are typically used in light scattering/transmissivity detection schemes, and the like. Typically, light selection parameters are well known to those of skill in the art.

The detector can exist as a separate unit, but is preferably integrated with a controller system, into a single instrument. Integration of these functions into a single unit facilitates connection of these instruments with the computer (described below), by permitting the use of few or a single communication port(s) for transmitting information between the controller, the detector and the computer.

Computer

As noted above, either or both of the fluid direction system and/or the detection system are coupled to an appropriately programmed processor or computer which functions to instruct the operation of these instruments in accordance with preprogrammed or user input instructions, receive data and information from these instruments, and interpret, manipulate and report this information to the user. As such, the computer is typically appropriately coupled to one or both of these instruments (e.g., including an analog to digital or digital to analog converter as needed).

The computer typically includes appropriate software for receiving user instructions, either in the form of user input into a set parameter fields, e.g., in a GUI, or in the form of preprogrammed instructions, e.g., preprogrammed for a variety of different specific operations. The software then converts these instructions to appropriate language for instructing the operation of the fluid direction and transport controller to carry out the desired operation. For example, the software optionally directs the fluid direction system to transport the sample into the device via a pressure source, into a pressure controlled deep reaction channel or mixing channel, or into a shallow loading channel using electrokinetic forces. In addition, the software optionally directs the fluid direction system to inject or cross inject the sample from the shallow loading channel or the deep mixing channel into the shallow separation channel in which the components of the sample are separated. Any other movement necessary to assay, separate, or detect the sample is also optionally directed by the software instructions.

The computer then receives the data from the one or more sensors/detectors included within the system, and interprets the data, either provides it in a user understood format, or uses that data to initiate further controller instructions, in accordance with the programming, e.g., such as in monitoring and control of flow rates, temperatures, applied voltages, and the like.

In the present invention, the computer typically includes software for the monitoring of materials in the channels. Additionally the software is optionally used to control electrokinetic or pressure-modulated injection or withdrawal of material.

In addition, the computer optionally includes software for deconvolution of the signal or signals from the detection system. For example, the deconvolution quantitates the amounts of substrate and product in an enzyme assay.

Example Integrated System

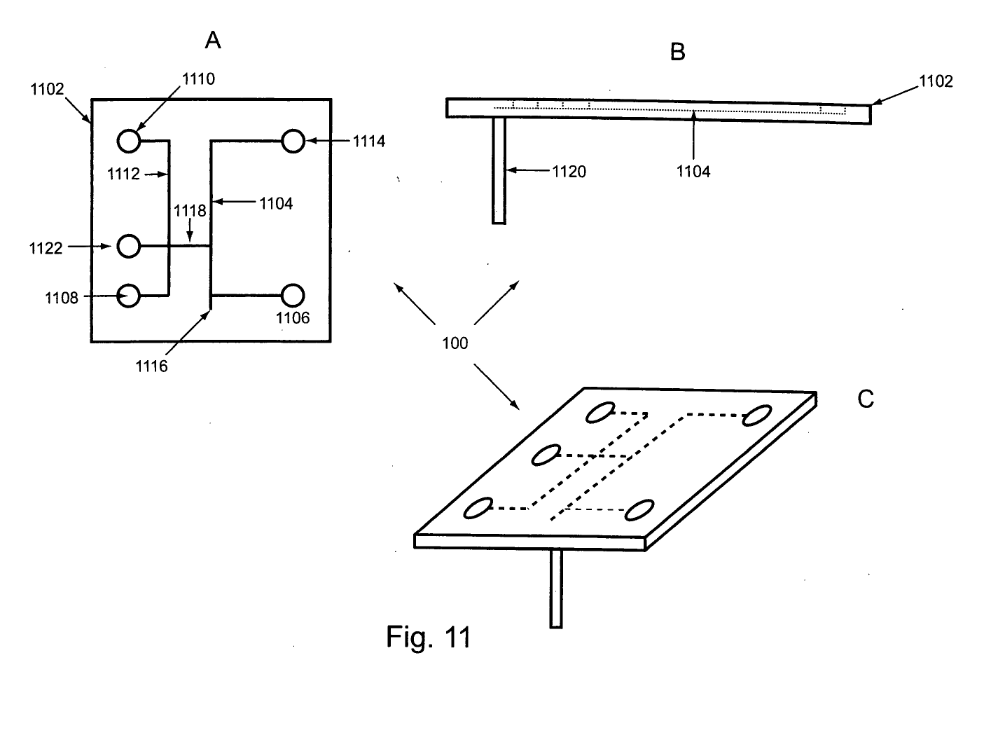

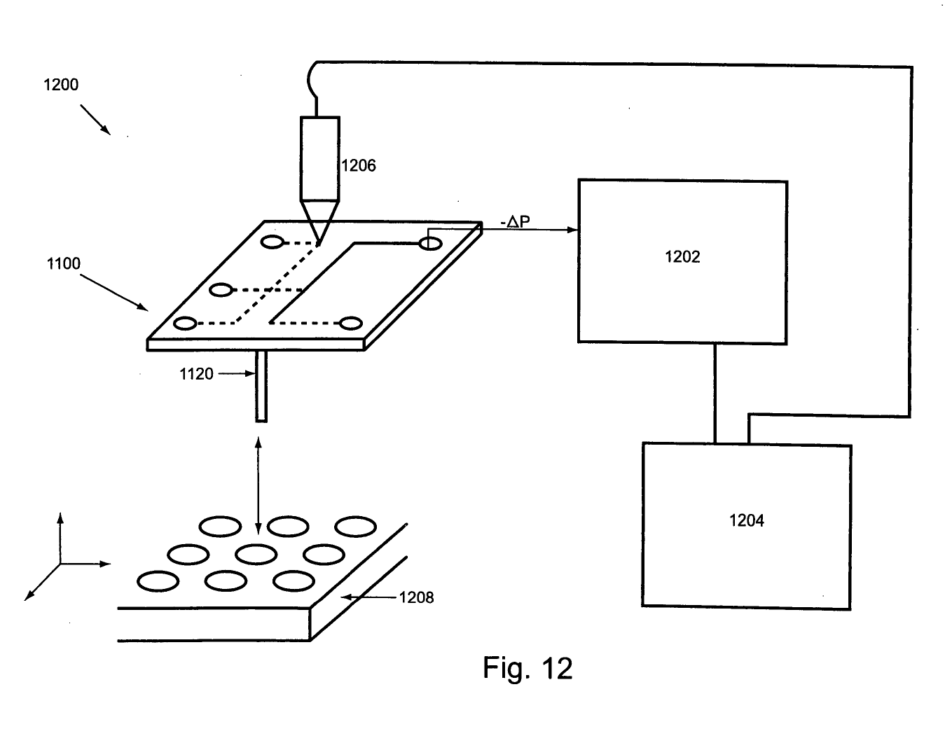

FIG. 11, Panels A, B, and C and FIG. 12 provide additional details regarding example integrated systems that are optionally used to practice the methods herein. As shown, body structure 1102 has mixing channel 1104 disposed therein. A sample or mixture of components is optionally flowed from pipettor channel 1120 towards reservoir 1114, e.g., by applying a vacuum at reservoir 1114 (or another point in the system). Additional materials, such as buffer solutions, enzymes, substrates, and the like, as described above are optionally flowed from wells 1106 or 1114 and into mixing channel 1104. Flow from these wells is typically performed by modulating fluid pressure as described. The sample or components are typically separated in separation channel 1112, in which flow is typically electrokinetically driven. Additionally, loading channel 1118 is optionally used to load the sample from mixing channel 1104 and to inject the sample into separation channel 1112. Fluid flow in loading channel 1118 is also typically controlled by electrokinetic forces. For example a voltage gradient applied across separation channel between reservoirs 1110 and 1108 is used to cross-inject material from loading channel 1118 into separation channel 1112. The arrangement of channels depicted in FIG. 3 is only one possible arrangement out of many which are appropriate and available for use in the present invention. Alternatives include, but are not limited to, the devices provided in FIGS. 1, 2, 3, 4, and 9.

Samples and materials are optionally flowed from the enumerated wells or from a source external to the body structure. As depicted, the integrated system optionally includes pipettor channel 1120, e.g., protruding from body 1102, for accessing a source of materials external to the microfluidic system. Typically, the external source is a microtiter dish or other convenient storage medium. For example, as depicted in FIG. 12, pipettor channel 1120 can access microwell plate 1208, which includes sample materials, enzymes, substrates, and the like, in the wells of the plate.

Detector 1206 is in sensory communication with separation channel 1112, detecting signals resulting, e.g., from substrates and products of interest. Detector 1206 is optionally coupled to any of the channels or regions of the device where detection is desired. Detector 1206 is operably linked to computer 1204, which digitizes, stores, and manipulates signal information detected by detector 1206, e.g., using any of the instructions described above, e.g., or any other instruction set, e.g., for determining retention time, molecular weight, concentration, or identity.

Fluid direction system 1202 controls voltage, pressure, or both, e.g., at the wells of the systems or through the channels of the system, or at vacuum couplings fluidly coupled to mixing channel 1104 or other channel described above. Optionally, as depicted, computer 1204 controls fluid direction system 1202. In one set of embodiments, computer 1204 uses signal information to select further parameters for the microfluidic system. For example, upon detecting the presence of a component of interest in a sample from microwell plate 1208, the computer optionally directs addition of a potential modulator of the component of the interest into the system.

Kits

Generally, the microfluidic devices described herein are optionally packaged to include reagents for performing the device's preferred function. For example, the kits can include any of microfluidic devices described along with assay components, reagents, sample materials, enzymes, substrates, particle sets, salts, separation matrices, control materials, or the like. Such kits also typically include appropriate instructions for using the devices and reagents, and in cases where reagents are not predisposed in the devices themselves, with appropriate instructions for introducing the reagents into the channels and/or chambers of the device. In this latter case, these kits optionally include special ancillary devices for introducing materials into the microfluidic systems, e.g., appropriately configured syringes/pumps, or the like (in one preferred embodiment, the device itself comprises a pipettor element, such as an electropipettor for introducing material into channels and chambers within the device). In the former case, such kits typically include a microfluidic device with necessary reagents predisposed in the channels/chambers of the device. Generally, such reagents are provided in a stabilized form, so as to prevent degradation or other loss during prolonged storage, e.g., from leakage. A number of stabilizing processes are widely used for reagents that are to be stored, such as the inclusion of chemical stabilizers (i.e., enzymatic inhibitors, microcides/bacteriostats, anticoagulants), the physical stabilization of the material, e.g., through immobilization on a solid support, entrapment in a matrix (i.e., a gel), lyophilization, or the like.

Kits also optionally include packaging materials or containers for holding a microfluidic device, system or reagent elements.

### IV. EXAMPLE SEPARATIONS USING THE DEVICES AND METHODS OF THE INVENTION

### Example 1

### Demonstration of movement on a chip

The microfluidic device of FIG. 1, was used to demonstrate function of the device and perform separations. Reagents were placed in various reservoirs of the device and pumped through using electrokinetic forces and electrokinetic forces combined with pressure. Clean baseline separations were obtained on these devices with all parameter sets.

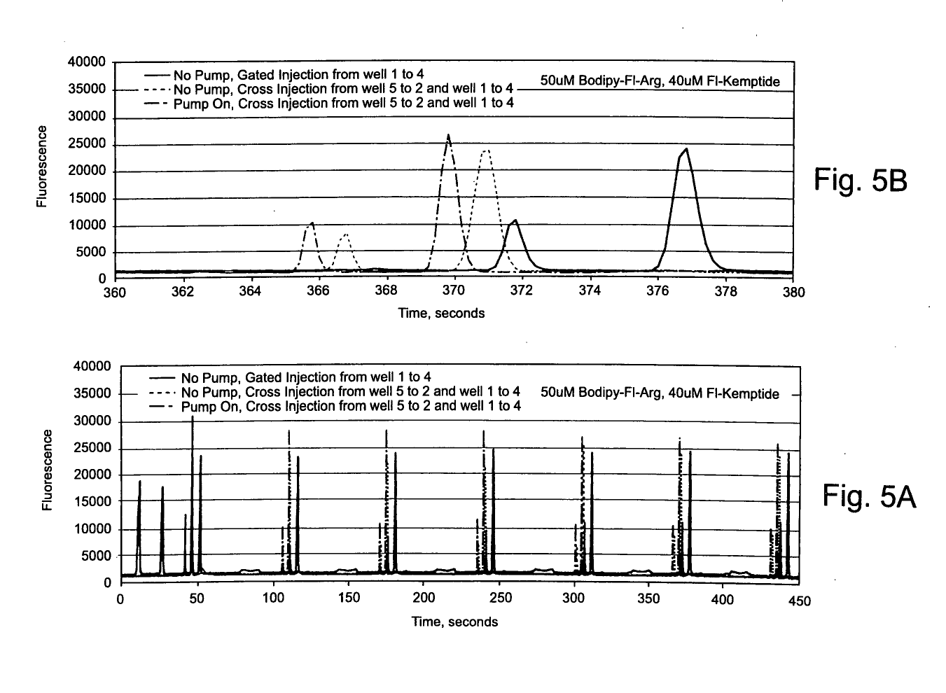

An anionic substrate and a neutral marker were used to show that fluid flow, e.g., on a planar device, is completely controlled by electroosmosis and electrophoresis. Fl-Kemptide (40 μM) and Bodipy-Fl-arginine (50 μM) were placed in reservoir 112. A gated injection via reservoir 110 to reservoir 114 showed the channel dimensions in the device were adequate for good separation and the short path length did not hinder detection. Next the probes were loaded into reservoir 102 and electrokinetically moved to reservoir 110. A cross injection using reservoirs 112 and 114 allowed for the volume of fluid at the intersection of shallow loading channel 108 and shallow separation channel 116 to be analyzed. Good baseline resolved peaks were observed as shown in FIG. 5, A and B. Finally, the cross injection was repeated with a vacuum pump connected to reservoir 106. Here both electrokinetic and pressure driven flow was used simultaneously to control reagent movement and device function. Pressure was used to draw the dyes from reservoir 102 to reservoir 106. The loading and separation were achieved electrokinetically in shallow channel 108 and 116. The pump remained on during the load and separation steps. The magnified view in FIG. 5B shows good separation regardless of the mechanism of fluid and reagent movement. All peak areas are of comparable size. The peak height at half-maximum is independent of the sample injection method. Therefore, the data show that the combined electrophoretic and pressure driven flow using deep and shallow channels provides clean baseline resolved separations.

Experiments were run in a pH 7.5 assay buffer comprising 100 mM HEPES, 1 M NDSB-195, 5 mM MgCl₂, and 0.1% TritonX-100. Reagents were added to the buffers on the day of use.

### Example 2

### PKA Phosphorylation of Fl-Kemptide

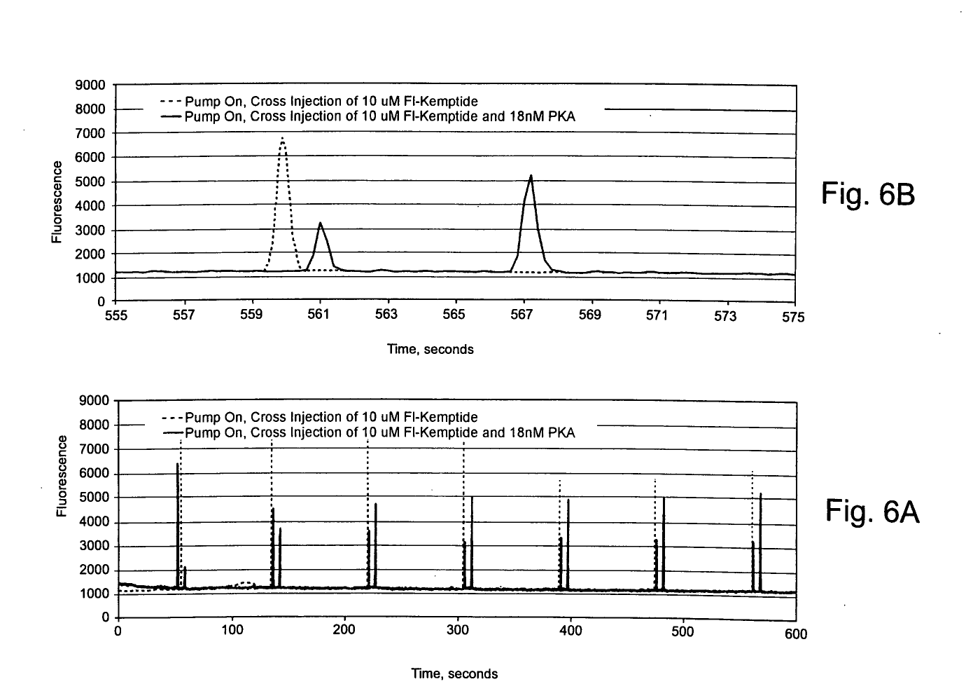

The device shown in FIG. 1 was used to monitor a phosphorylation of Fl-Kemptide by PKA over time. FIG. 6, panel A shows repetitive injections of substrate only overlaid with repetitive injections of PKA and substrate when the reagents were allowed to incubate in reservoir 102. In both instances, the reagents were pumped via pressure driven flow to reservoir 106, loaded electrokinetically to reservoir 110, and then electrokinetically injected into shallow separation channel 116. The evolution of substrate to product is evident from the results shown in FIG. 6, Panel A. The separation is complete even in the presence of pumped flow during the separation step as shown in the magnified view of FIG. 6B. The clear symmetric peak shape indicates that parabolic flow in the shallow separation channel was not significant.

Experiments were run in a pH 7.5 assay buffer comprising 100 mM HEPES, 1 M NDSB-195, 5 mM MgCl₂, 100 μM ATP, 10 mM DTT, and 0.1% TritonX-100. Reagents were added to the buffers on the day of use.

In conclusion, using the device of FIG. 1 both siphoning and electrokinetic flow delivered comparable reagent amounts to the load and separation channels and the difference in channel depth was sufficient to reduce parabolic flow in the load and separation channels. This reduction in parabolic flow makes electrokinetic movement of reagents possible while the vacuum is drawing fluid. In addition, no significant difference in resolution or efficiency was observed for the separation in the presence and absence of pressure driven flow and the reduced pathlength for the shallow separation channels did not negatively affect the ability to detect the species of interest at relevant assay concentrations.

### Example 3

### Performing Separations in a Device Utilizing an Electroosmotic Pump

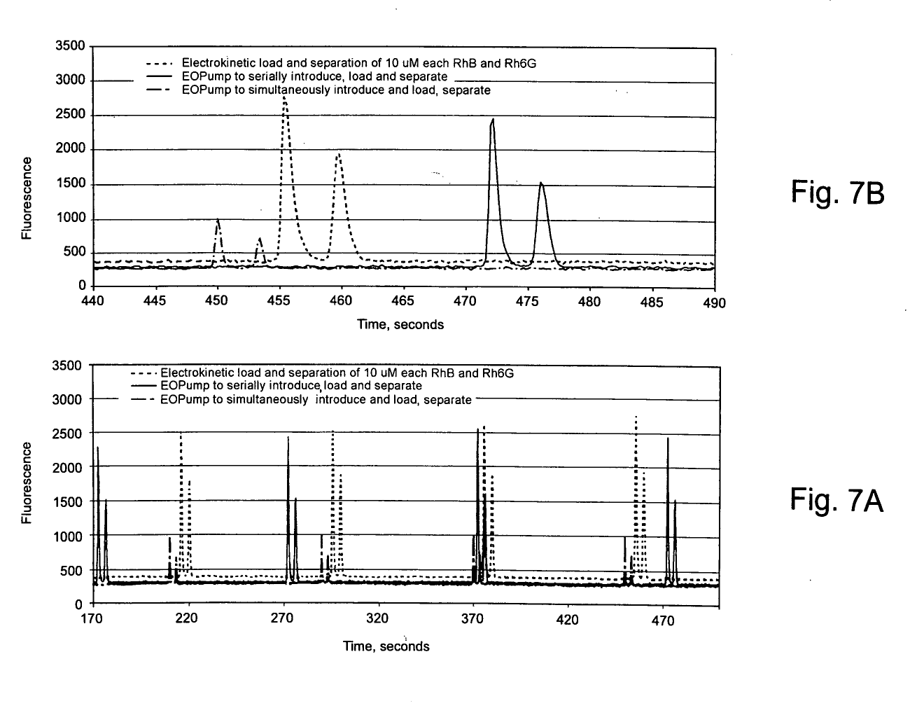

The microfluidic device in FIG. 2 was used to demonstrate the function and separation efficiency of a device containing an electroosmotic pump. The neutral and cationic rhodamine analogs RhB and Rh6G were separated, as shown in FIG. 7. Experiments were performed in a pH 7.5 assay buffer comprising 100 mM HEPES, 1 M NDSB-195, 5 mM MgCl₂, and 0.1% TritonX-100. Reagents were added to the buffers on the day of use.

First, dyes were placed in reservoir 202 and electrokinetically pumped to reservoir 210. They were then cross-injected and detected about one-third of the length into shallow separation channel 216. Loading of the sample into shallow separation channel 216 and separation of the components were performed with the electroosmotic pump off. The dyes were moved directly by electroosmosis and electrophoresis.

Second, the electroosmotic pump, comprising shallow pump channel 222, reservoirs 220, 206, and 218, and channel regions 224 and 226, was implemented to move the dyes from reservoir 202 to reservoir 206. The dyes were drawn into deep mixing channel 204 using the electroosmotic pump and then the pump was turned off. With the pump off, the dyes were then electrokinetically loaded into shallow loading channel 208. The two peaks were then baseline separated in shallow separation channel 216. The pump was implemented to pull fluid into deep mixing channel 204 by applying a high voltage at reservoir 220 and a low voltage at reservoir 206. Controlling the current at those reservoirs also turned off the pump so that zero current was drawn when the pump was turned off.

Finally, the preceding sequence of fluid movements and transfer was repeated with the pump off. First the electroosmotic pump was left on while shallow loading channel 208 was drawing negative current, such that both sample draw into deep mixing channel 204 and sample load into shallow loading channel 208 occurred simultaneously. Then the pump was turned off while separation took place.

The results are shown in FIG. 7, Panels A and B. Pumped sample introduction, followed by load and separation yielded peaks of the order of the direct electrokinetic separation approach. Simultaneous sample introduction and load gave reduced peak areas, due to diminished sample load. The efficient pumping competes with the electrokinetic load and less material makes it to the injector for separation on shallow separation channel 216. Despite the reduced peak areas, a good separation was still achieved and lowering the voltage difference between reservoirs 220 and 206 would decrease the pressure-induced flow and reduce the competition that caused the reduced peak areas.

### Example 4

### PKA Reaction in an Electroosmotically Pumped Device

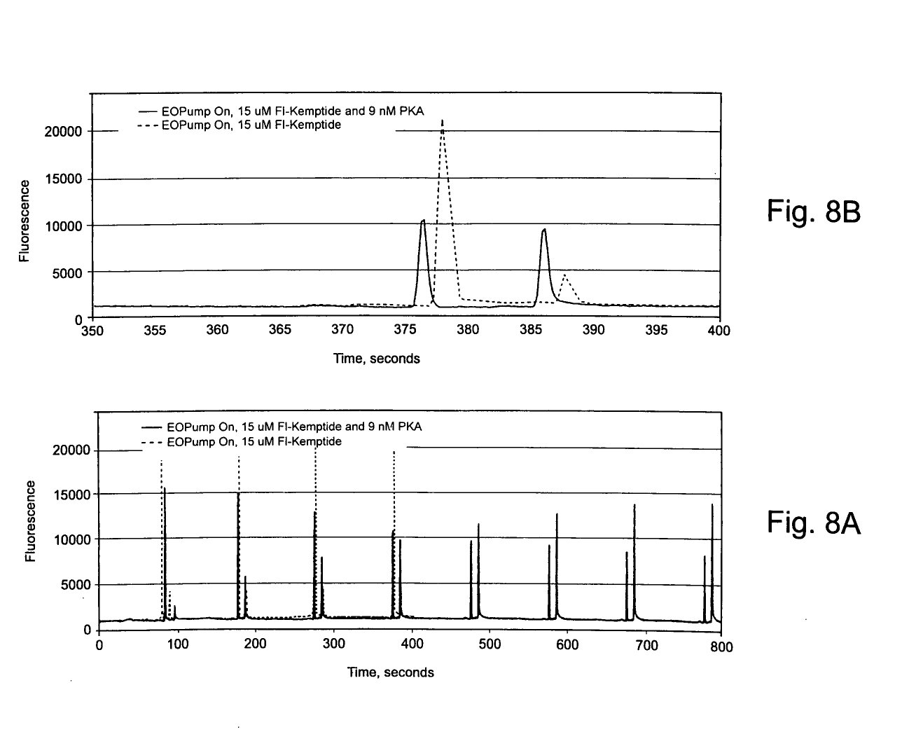

A PKA reaction was performed in the device of FIG. 2 in a pH 7.5 assay buffer comprising 100 mM HEPES, 1 M NDSB-195, 5 mM MgCl₂, 100 μM ATP, 10 mM DTT, and 0.1% TritonX-100. The PKA reaction was performed in a serial fashion as described above in Example 3. The sample was introduced into the system by electroosmotic pumping, e.g., a 20 second pump, then loaded into shallow loading channel 208, e.g., for a 20 second electrokinetic load, and then injected into shallow separation channel 216, e.g., using a 60 second injection followed by separation. The results are plotted in FIG. 8, Panels A and B. The plot contains an overlay of substrate only signals over time and the trace of PKA and Fl-Kemptide mixed in reservoir 202 and injected over time. The reaction progression confirms the ability of the electroosmotic pump to move neutral and charged reagents. Moreover, the facility with which one can generate pressure driven flow in a completely integrated chip for separation is clearly demonstrated. The obvious baseline resolution of the dyes and reaction products is depicted in FIGS. 7B and 8B.

In conclusion, the electroosmotically pump in the device of FIG. 2 was successfully used to generate pressure driven flow in the selected channel lengths. Simple filling of the shallow channels of the electroosmotic pump was sufficient to fabricate the pump and the high salt did not interfere with the chemistry or fluid movement in other areas of the device. Furthermore, the parabolic flow associated with pressure driven flow was conveniently switched on and off by controlling the applied voltages at the end of the salt containing channels that comprise the electroosmotic pump.

### Example 5

### High Throughput Separations

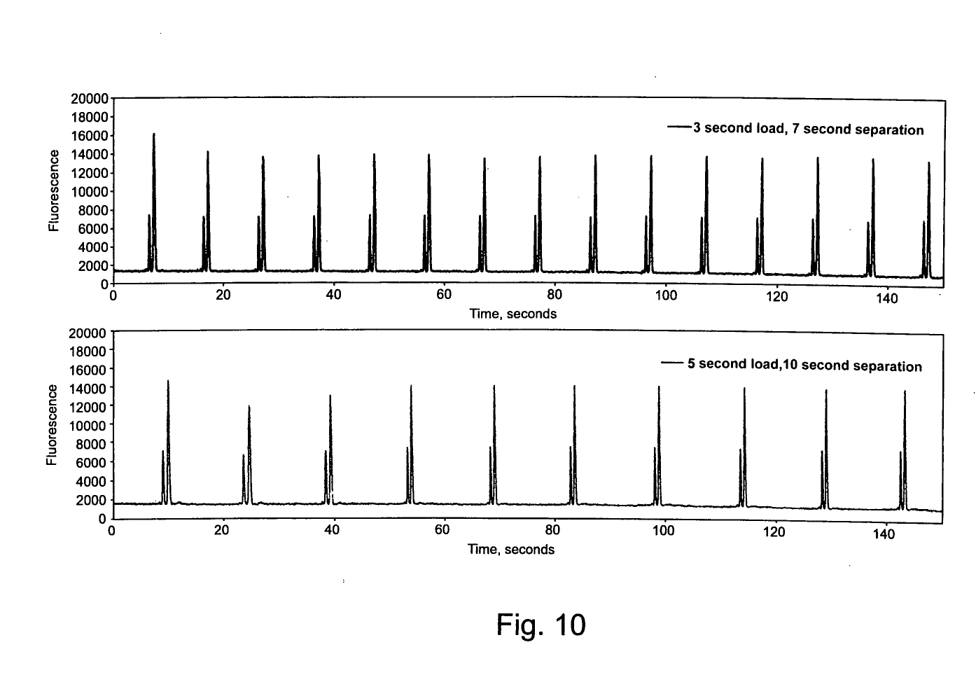

High throughput separations using the microfluidic device design of FIG. 1 have been demonstrated. The separation of fluorescein labeled Bodipy-Fl-arginine and Fl-Kemptide is shown in FIG. 10 with a 10 second duty cycle (3 second load and 7 second separation) and a 15 second duty cycle (5 second load and 10 second separation). Both examples provide baseline separation of the components. The experiments were carried out using 25 μM Bodipy-Fl-arginine and 20 μM Fl-Kemptide in a PKA assay buffer comprising 100 mM HEPES at pH 7.5, IM NDSB-195, 5 mM MgCl2, 0.1% TritonX-100.

This experiment demonstrates that the design of the device is useful for complex high-throughput applications. Furthermore, the fluorescence trace is not complicated by pressure fluctuations in the deep channels. For example, in devices utilizing sipper capillaries, spontaneous injection peaks may be observed, e.g., in enzymatically generated fluorescence traces, due to pressure fluctuations in the device as the sipping capillary is moved, e.g., between sample wells on a microtiter plate. In the present experiment, the separation peaks are observed on a buffer only background, indicating that the spontaneous injection perturbations did not complicate the signal.

The discussion above is generally applicable to the aspects and embodiments of the invention described in the claims.

Moreover, modifications can be made to the method and apparatus described herein without departing from the spirit and scope of the invention as claimed, and the invention can be put to a number of different uses including the following:

The use of a microfluidic system for performing separations as set forth herein.

The use of a microfluidic system for separating a substrate from a product in an enzyme reaction.

The use of a microfluidic device or system as described herein to integrate pressure driven flow with electrokinetic flow.

An assay utilizing any one of the microfluidic systems or devices described herein.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

1. A method of performing a separation in a microfluidic device, the method comprising:
(i) flowing at least a first sample through a deep mixing channel by applying pressure to the first sample in the deep mixing channel, which first sample comprises one or more components;
(ii) flowing the first sample into a shallow separation channel by applying an electrokinetic force to the first sample, which shallow separation channel is fluidly coupled to the deep mixing channel; and, (iii) electrokinetically separating at least two of the one or more components of the first sample in the shallow separation channel, thereby performing a separation.

2. The method of claim 1, further comprising introducing a second sample into the deep mixing channel concurrent with electrokinetically separating the first sample.

3. The method of claim 1, further comprising electrokinetically loading the first sample from the deep mixing channel into a shallow loading channel and electrokinetically injecting the first sample from the shallow loading channel into the shallow separation channel, wherein the shallow loading channel is fluidly coupled to the deep mixing channel and intersects the shallow separation channel.

4. The method of claim 3, comprising providing the shallow loading channel to have a depth between about 1 μm and about 20 μm and a width between about 1 μm and about 20 μm.

5. The method of claim 4, comprising providing the shallow loading channel to have a depth between about 1 μm and about 15 μm and a width between about 5 μm and about 15 μm.

6. The method of claim 5, comprising providing the shallow loading channel to have a depth between about 3 μm and about 10 μm and a width between about 5 μm and about 10 μm

7. The method of claim 6, comprising providing the shallow loading channel to have a depth of about 3 μm and a width of about 9 μm.

8. The method of claim 3, further comprising introducing a second sample into the deep mixing channel concurrent with loading the first sample into the shallow loading channel.

9. The method of claim 8, further comprising applying substantially reduced pressure or no pressure during the separating step.

10. The method of claim 1, further comprising reacting at least the first sample with one or more reagents in the deep mixing channel, resulting in at least a first reacted sample, which first reacted sample comprises one or more components.

11. The method of claim 10, comprising providing the first sample to comprise a substrate and the one or more reagents to comprise an enzyme, and reacting the substrate and enzyme to produce a product.

12. The method of claim 1, comprising providing the deep mixing channel to have a first cross-sectional area and the shallow separation channel to have a second cross-sectional area, wherein the first cross-sectional area is greater than the second cross-sectional area.

13. The method of claim 1, comprising providing the deep mixing channel to have a depth between about 5 μm and about 100 μm and a width between about 5 μm and about 100 μm.

14. The method of claim 13, comprising providing the deep mixing channel to have a depth between about 10 μm and about 50 μm and a width between about 20 μm and about 50 μm.

15. The method of claim 14, comprising providing the deep mixing channel to have a depth between about 10 μm and about 20 μm and a width between about 35 μm and about 45 μm.

16. The method of claim 15, comprising providing the deep mixing channel to have a depth of about 15 μm and a width of about 40 μm.

17. The method of claim 1, comprising providing the shallow separation channel to have a depth between about 1 μm and about 20 μm and a width between about 1 μm and about 20 μm.

18. The method of claim 17, comprising providing the shallow separation channel to have a depth between about 1 μm and about 15 μm and a width between about 5 μm and about 15 μm.

19. The method of claim 18, comprising providing the shallow separation channel to have a depth between about 3 μm and about 10 μm and a width between about 5 μm and about 10 μm

20. The method of claim 19, comprising providing the shallow separation channel to have a depth of about 3 μm and a width of about 9 μm.

21. The method of claim 1, comprising providing the deep mixing channel to have a first depth and the shallow separation channel to have a second depth, which first depth is at least about 2 times as deep as the second depth.

22. The method of claim 1, comprising providing the deep mixing channel to have a first depth and the shallow separation channel to have a second depth, which first depth is at least about 4 to about 5 times as deep as the second depth.

23. The method of claim 1, comprising providing the deep mixing channel to have a first depth and the shallow separation channel to have a second depth, which first depth is at least about 10 times as deep as the second depth.

24. The method of claim 1, comprising providing the shallow separation channel to comprise a separation matrix.

25. The method of claim 24, wherein the separation matrix comprises polyacrylamide, linear polyacrylamide, cross-linked polyacrylamide, non cross-linked polyacrylamide, polydimethylacrylamide, agarose, cellulose, or polydimethylacrylamide/co-acrylic acid.

26. The method of claim 1, further comprising providing a pressure source operably coupled to the deep mixing channel, which pressure source introduces the first sample into the deep mixing channel.

27. The method of claim 26, wherein the pressure source comprises a vacuum source.

28. The method of claim 26, wherein the pressure source comprises an electroosmotic pump.

29. The method of claim 28, wherein the electroosmotic pump comprises a channel comprising a fluidic material, which fluidic material comprises a salt.
